(19) United States
(12) Patent Application Publication
(10) Pub. No.: US 2021/0179806 A1
(43) Pub. Date: Jun. 17, 2021

(54) CABLE END AND CORRESPONDING MANUFACTURING METHOD

(71) Applicant: SILEC CABLE, Montereau-Fault-Yonne (FR)

(72) Inventors: Carlos Jose PEREIRA, Thoury Ferottes (FR); Rachid AZZIMANI, Montereau-Fault-Yonne (FR); Isabelle DENIZET, La Brosse Montceaux (FR); Mohamed MAMMERI, Paron (FR)

(21) Appl. No.: 16/760,811

(22) PCT Filed: Nov. 5, 2018
(86) PCT No.: PCT/EP2018/080214

§ 371 Date: Apr. 30, 2020

(30) Foreign Application Priority Data
Nov. 3, 2017 (FR) 1760353

(51) Int. Cl. C08K 3/22; C08L 23/16; H01B 3/28; H02G 15/02

(52) U.S. Cl. CPC C08K 3/22; C08L 23/16; H01B 9/00; H02G 15/02; C08K 2003/2227; H01B 3/28

(57) ABSTRACT

A cable end is provided, such as an end of a cable for transporting electric energy. The cable end includes an electrically insulating layer obtained from a composition including at least: a polymer matrix, the polymer matrix being made up of one or more synthetic rubbers; a metal hydroxide as metallic filler, the metal hydroxide being present in the composition, such that for 100 parts by weight of composition, the metal hydroxide is present in a larger proportion by weight in the composition than the polymer matrix; a coupling agent between the polymer matrix and the metal hydroxide; and a plasticizer. A method of producing a cable end is also provided.

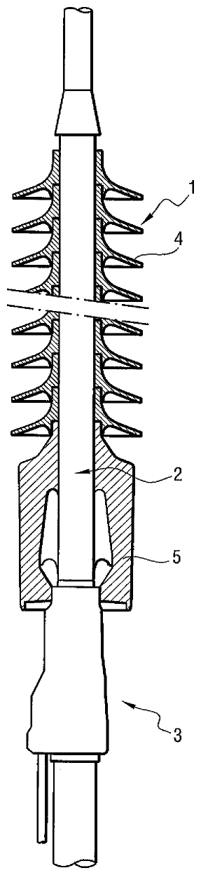

The invention relates to a cable end. More particularly, although not exclusively, the invention relates to a cable end for power transmission such as a cable end for electric power transmission, for example a cable end for high voltage electric power transmission.

The invention also relates to a method for the manufacture of a cable end of this type.

### TECHNICAL BACKGROUND OF THE INVENTION

Cable ends for power transmission, in particular cable ends for high voltage electric power transmission, are subjected to particularly severe conditions which are both external (rain, heat, pollution, etc.) as well as internal (tracking of electric arcs generated by the high voltage electric current that circulates in the conductive core of the cable).

In particular, the dimensions of said ends have to be particularly well designed in order to avoid being deteriorated rapidly.

Thus, covering said ends with a layer of electrically insulating material, the layer comprising a succession of skirts that can enhance the leakage paths of said ends, has been proposed.

However, even with a layer of this type, the ends have a tendency to be damaged too quickly.

### AIM OF THE INVENTION

One aim of the invention is to propose a cable end comprising a layer that can be used to prevent too rapid a deterioration of this end.

The invention also aims to propose a method for the manufacture of a cable end of this type.

### BRIEF DESCRIPTION OF THE INVENTION

With a view to achieving this aim, a cable end, such as a cable end for electric power transmission, is proposed, the cable end comprising an electrically insulating layer obtained from a composition comprising at least:
a polymer matrix, the polymer matrix being constituted by one or more synthetic rubbers,
a metal hydroxide as a metallic filler, the metal hydroxide being present in the composition in a manner such that the parts by weight of metal hydroxide is greater than the parts by weight of polymer matrix per hundred parts by weight of the composition,
a coupling agent between the polymer matrix and the metal hydroxide,
a plasticizer.

By means of the combination of a polymer matrix formed from synthetic rubber(s), a metal hydroxide in a larger proportion by weight than the polymer matrix (per 100 parts by weight of the composition), a coupling agent promoting their interaction, and a plasticizer, the composition can be used to produce a layer of electrically insulating material that is particularly resistant to tracking (this may also be termed an “anti-tracking” layer), and in particular to electric arcs which could circulate in the end of the associated cable end, or in fact to erosion.

The synergy between the polymer matrix formed from synthetic rubber, the metal hydroxide, the coupling agent and the plasticizer within the composition can thus render the layer generated from this composition particularly resistant, in a manner such that it can age better and thus also enable better ageing of the associated cable end.

In accordance with one embodiment, the composition comprises between 20 and 40 parts by weight of the polymer matrix per hundred parts by weight of the composition.

In accordance with one embodiment, the composition comprises between 30 and 35 parts by weight of the polymer matrix per hundred parts by weight of the composition.

In accordance with one embodiment, the polymer matrix is constituted by one or more EPDMs and/or by one or more EPRs.

In accordance with one embodiment, at least one of the EPDMs and/or at least one of the EPRs comprises between 15 and 85 parts by weight of ethylene motifs per 100 parts by weight of the EPDM and/or of the EPR under consideration.

In accordance with one embodiment, each EPDM and/or EPR comprises between 15 and 85 parts by weight of ethylene motifs per 100 parts by weight of the EPDM and/or of the EPR under consideration. In accordance with one embodiment, at least one of the EPDMs comprises between 0 parts and 15 parts by weight of diene motifs per 100 parts by weight of the EPDM, the value 0 being excluded from the range.

In accordance with one embodiment, each EPDM comprises between 0 part and 15 parts by weight of diene motifs per 100 parts by weight of the EPDM, the value 0 being excluded from the range.

In accordance with one embodiment, the composition comprises between 40 and 70 parts by weight of metal hydroxide per hundred parts by weight of the composition.

In accordance with one embodiment, the composition comprises between 45 and 55 parts by weight of metal hydroxide per hundred parts by weight of the composition.

In accordance with one embodiment, the metal hydroxide is a natural or synthetic aluminum hydroxide and/or a natural or synthetic magnesium hydroxide.

In accordance with one embodiment, the composition comprises between 0.1 and 2 parts by weight of the coupling agent per hundred parts by weight of the composition.

In accordance with one embodiment, the composition comprises between 0.1 and 0.4 parts by weight of the coupling agent per hundred parts by weight of the composition.

In accordance with one embodiment, the coupling agent is silane-based.

In accordance with one embodiment, the plasticizer is constituted by one or more oils.

In accordance with one embodiment, at least one oil is a silicone oil.

The invention also concerns a method for the manufacture of a cable end comprising an electrically insulating layer, the method comprising the step of mixing the composition as described above and extruding or molding the composition mixed thereby in order to produce said layer.

Other characteristics and advantages of the invention will become apparent from the description below of a particular and non-limiting embodiment of the invention.

### BRIEF DESCRIPTION OF THE DRAWINGS

The invention will be better understood with the aid of the description below, made with reference to the single accompanying FIGURE which shows part of a cable end in accordance with a particular embodiment of the invention.

### DETAILED DESCRIPTION OF A PARTICULAR EMBODIMENT OF THE INVENTION

Throughout the present description and the corresponding claims, unless specified otherwise, all numbers expressing amounts, quantities, percentages, etc. should be understood to be preceded in all cases by the term “approximately”. Furthermore, all the ranges include any combination of the maximum and minimum limits described and any intermediate range, combination and intermediate range which might or might not have been explicitly indicated herein, unless specified otherwise.

In at least one of the aforementioned aspects, the present disclosure may be modified in accordance with one or more of the embodiments below, and which may be combined together.

Throughout the present description and the corresponding claims, the term “a” or “an” should be understood to mean “one or at least one” and the singular includes the plural and the plural includes the singular, unless it is obvious that this is not the case. This is solely for the sake of convenience, in order to provide a general sense of the disclosure.

In accordance with one embodiment, the composition comprises a polymer matrix based on synthetic rubber(s).

The composition comprises between 20 and 40 parts by weight of the polymer matrix and, for example, between 30 and 35 parts by weight of the polymer matrix form.

In accordance with one embodiment, the polymer matrix is based on at least one amorphous rubber. The polymer matrix is, for example, based on an amorphous rubber comprising ethylene-propylene chains.

The polymer matrix is constituted by one or more synthetic rubbers. As an example, the polymer matrix is constituted by one or more synthetic rubbers comprising ethylene-propylene chains.

In accordance with one embodiment, the polymer matrix is constituted by a single rubber. In accordance with one embodiment, the polymer matrix is constituted by a single EPDM (for Ethylene-Propylene-Diene Monomer) and/or by an ethylene-propylene rubber (better known by the acronym EPR, for “ethylene propylene rubber”).

In the case in which the polymer matrix comprises a single EPDM, the EPDM comprises between 15 parts and 85 parts by weight of ethylene motifs and, for example, between 20 and 85 parts by weight of ethylene motifs per 100 parts by weight of EPDM. In accordance with one embodiment, the EPDM comprises between 40 and 85 parts by weight of ethylene motifs, and, for example, between 45 parts and 85 parts by weight of ethylene motifs, per 100 parts by weight of EPDM.

In accordance with one embodiment, the EPDM comprises between 0 and 15 parts by weight of diene motifs (the value being excluded from the range, of course) and, for example, between 0 and 11 parts by weight of diene motifs (the value 0 being excluded from the range, of course), per 100 parts by weight of EPDM. In accordance with one embodiment, the EPDM comprises between 4 and 5 parts by weight of diene motifs per 100 parts by weight of EPDM. In accordance with one embodiment, the EPDM comprises between 0.5 and 15 parts by weight of diene motifs and, for example, between 1.2 and 15 parts by weight of diene motifs per 100 parts by weight of EPDM.

The EPDM has a viscosity of between 40 and 55 mm²/s.

In the case in which the polymer matrix comprises a single EPR, the EPR comprises between 15 and 85 parts by weight of ethylene motifs and, for example, between 20 and 85 parts by weight of ethylene motifs per 100 parts by weight of EPR. In accordance with one embodiment, the EPR comprises between 40 and 85 parts by weight of ethylene motifs and, for example, 45 and 85 parts by weight of ethylene motifs and, for example, between 55 and 85 parts by weight of ethylene motifs, per 100 parts by weight of EPR.

The composition furthermore comprises a metal hydroxide, as a metallic filler, present in the composition in a manner such that the metal hydroxide is present in a larger proportion by weight in the composition than the polymer matrix per 100 parts by weight of composition.

The composition comprises between 40 and 70 parts by weight of metal hydroxide per hundred parts by weight of the composition and, for example, between 45 and 55 parts by weight of metal hydroxide per hundred parts by weight of the composition.

The metal hydroxide is natural or synthetic.

In accordance with one embodiment, the metal hydroxide is aluminum hydroxide.

In accordance with one embodiment, the metal hydroxide is based on alumina trihydrate.

In accordance with one embodiment, the metal hydroxide is selected in a manner such that it is constituted by particles the diameter of which is between 0.1 and 3.5 micrometers and, for example, between 0.2 and 3 micrometers.

In accordance with one embodiment, the metal hydroxide is selected in a manner such that it is constituted by particles with a specific surface area of between 0.5 and 7 square meters per two grams, for example between 1 and 6 square meters per two grams.

The composition also comprises an agent for coupling between the polymer matrix and the metal hydroxide.

The composition comprises between 0.1 and 2 parts by weight of the coupling agent per hundred parts by weight of the composition and, for example, between 0.1 and 1 parts by weight of the coupling agent, and again by way of example, between 0.1 and 0.4 parts by weight of the coupling agent per hundred parts by weight of the composition.

The coupling agent is based on silane, for example.

In accordance with one embodiment, the coupling agent is based on vinyltris(2-methoxyethoxy)silane (VTMOEO) or, for example, on treated vinyltris(2-methoxyethoxy)silane.

In accordance with one embodiment, the composition also comprises one or more plasticizers.

The composition thus comprises between 8 and 12 parts by weight of plasticizer(s) and, for example, between 9.5 and 10.5 parts by weight of plasticizer(s), per hundred parts by weight of the composition.

As an example, the plasticizer is constituted by one or more oils.

The plasticizer is constituted, for example, by at least one paraffin oil and/or silicone oil.

As an example, at least one oil forming the plasticizer is a silicone oil. The silicone oil is a polydimethylsiloxane oil, for example.

The silicone oil is, for example, a polydimethylsiloxane oil with a viscosity of between 500 and 2000 mm²/s.

The composition comprises, for example, between 1 and 4 parts by weight of silicone oil and, for example, between 2 and 3 parts by weight of silicone oil per hundred parts by weight of the composition.

If the plasticizer comprises at least one paraffin oil, this is, for example, a paraffin oil the viscosity of which is between 35 and 50 mm²/s.

The composition then comprises, for example, between 6 and 9 parts by weight of paraffin oil and, for example, between 7 and 8 parts by weight of paraffin oil per hundred parts by weight of the composition.

In accordance with one embodiment, the composition comprises at least one other additive such as, for example, one or more anti-UV compound(s) and/or one or more peroxide(s) and/or one or more antioxidants(s) and/or one or more filler(s).

As an example, the composition comprises at least one filler which is not a metal hydroxide. In accordance with one embodiment, the composition comprises between 0.1 and 2 parts by weight of filler which is not a metal hydroxide and, for example, between 0.1 and 1 part by weight of filler which is not a metal hydroxide, and again by way of example, between 0.2 and 0.6 parts by weight of filler which is not a metal hydroxide, per hundred parts by weight of the composition.

The filler which is not a metal hydroxide is a semi-conducting filler, for example.

The semi-conducting filler is carbon black, for example. The semi-conducting filler is, for example, carbon black with an OAN (Oil Absorption Number) of 70 milliliters per 100 g.

As an example, the composition comprises at least one antioxidant. In accordance with one embodiment, the composition comprises between 0.05 and 0.4 parts by weight of antioxidant and, for example, between 0.1 and 0.3 parts by weight of antioxidant, per hundred parts by weight of the composition.

The antioxidant is phenol-styrene, for example.

As an example, the composition comprises at least one anti-UV compound. In accordance with one embodiment, the composition comprises between 4 and 8 parts by weight of anti-UV compound and, for example, between 5 and 7 parts by weight of anti-UV compound per hundred parts by weight of the composition.

The anti-UV is a mixture of at least two components, for example. The anti-UV is, for example, a mixture of zinc oxide and titanium dioxide.

The titanium dioxide is, for example, TiO₂ R2 (i.e. titanium dioxide in its rutile crystalline form).

The titanium dioxide is, for example, TiO₂ R2 with a surface treatment using aluminum, silicon and an organosilane. The titanium dioxide is, for example, TiO₂ R2 treated with silane.

In accordance with one embodiment, the composition comprises between 3 and 7 parts by weight of titanium dioxide and, for example, between 4 and 6 parts by weight of titanium dioxide, per hundred parts by weight of the composition.

In accordance with one embodiment, the composition comprises between 1 and 3 parts by weight of zinc oxide and, for example, between 1.1 and 2 parts by weight of zinc oxide, per hundred parts by weight of the composition.

As an example, the composition comprises at least one peroxide. In accordance with one embodiment, the composition comprises between 0.5 and 2 parts by weight of peroxide and, for example, between 1 and 1.5 parts by weight of peroxide, per hundred parts by weight of the composition.

The peroxide is dicumyl peroxide, for example.

The composition described above can be used to manufacture an electrically insulating layer which is particularly resistant to electrical tracking (it can also be termed an “anti-tracking” layer). In particular, an insulating layer of this type is resistant to electric arcs which could circulate in the end of the associated cable, or indeed resistant to erosion. This means that the behavior over time of said end can be improved.

Furthermore, the polymer matrix formed from synthetic rubber can be used to provide said layer with good ageing and good dielectric properties.

In addition, the metal hydroxide may be used to provide said layer with good properties as regards retarding the propagation of flames (“flame retardant properties” is the best known term).

In addition, the coupling agent can be used to facilitate mechanical and chemical cohesion between the polymer matrix and the metal hydroxide, improving the behavior of said layer.

In addition, the plasticizer can be used to make said composition more flexible.

The method for the manufacture of a layer of this type will now be described.

The composition defined above is mixed before being extruded.

The composition may therefore be mixed with the aid of an internal mixer before being dispensed into an independent extruder by injection.

In a variation, the composition may be mixed and extruded by the same continuous mixing machine.

In another variation, the composition is mixed and molded instead of being mixed and extruded.

As an example, and with reference to the single FIGURE, the composition may be used to form an electrically insulating layer 1 of an end 2 of a cable 3. The layer 1 is, for example, the outer layer of the end 2.

The layer 1 is disposed at the lower portion 5 and/or at the upper portion of said end 2 in a manner such as to form all or part of the outer electrically insulating sheath of said end 2.

The upper portion is shaped, for example, in a manner such as to have a succession of skirts 4 (only one being referenced here) along the longitudinal direction of the end 2.

This adapted shape can be used to reinforce the durability of the end 2.

The aforementioned end 2 is, for example, a cable end for electric power transmission. The layer 1 that is formed thereby is particularly suitable for an application to high voltage power transmission cable ends and, for example, for 60 to 250 kilovolt high voltage cable ends.

A particular example of the composition will now be provided.

In this example, the composition comprises (per hundred parts by weight of the composition):
between 25% and 40% by weight and, for example, between 30% and 35% by weight and, for example, 32% by weight of an EPDM as a polymer matrix,
between 43% and 58% by weight and, for example, between 48% and 53% by weight and, for example, 49.4% by weight of silane treated alumina trihydrate (better known by the acronym silane treated ATH, standing for “Alumina Trihydrate”), as the metal hydroxide,
between 0.1% and 0.5% by weight and, for example, between 0.2% and 0.4% by weight and, for example, 3% by weight of vinyltris(2-methoxyethoxy)silane as a coupling agent,
between 8% and 12% by weight and, for example, between 9.5% and 10.5% by weight and, for example, 10% by weight of plasticizer, the plasticizer being constituted by a silicone oil and a paraffin oil, with
   as an example, between 1% and 4% by weight of silicone oil and, for example, between 2% and 3% by weight of silicone oil and, for example, 2.5% by weight of silicone oil, and
   as an example, between 6% and 9% by weight of paraffin oil and, for example, between 7% and 8% by weight of paraffin oil and, for example, 7.5% by weight of paraffin oil,
and the complement being anti-UV compounds and/or one or more peroxide(s) and/or one or more anti-oxidant(s) and/or one or more filler(s) and/or other components.

An example of a compositions in accordance with a particular embodiment is described in Table 1 below.

TABLE 1

| | | | % by weight |
|---|---|---|---|
| | | | (per 100 |
| | | | parts by |
| | | | weight of |
| | Component used | | composition) |
| Polymer matrix | EPDM (55 parts by weight of | | 32 |
| | ethylene motifs; viscosity | | |
| | 45 to 48 mm²/s) | | |
| Metal hydroxide | Silane treated ATH | | 49.4 |
| Coupling agent | VTMOEO | | 0.3 |
| Plasticizer | Paraffin oil (viscosity 43 | | 7.5 |
| | mm²/s) | | |
| | Polydimethylsiloxane | | 2.5 |
| | silicone oil (viscosity | | |
| | 1000 mm²/s) | | |
| Additives | Other filler | Carbon | 0.5 |
| | | black | |
| | Anti-oxidant | Phenol- | 0.2 |
| | | styrene | |
| | Anti-UV | TiO₂ R2 3,9 | 5.0 |
| | | silane | |
| | | ZnO | 1.4 |
| | Peroxide | Dicumyl | 1.2 |
| | | peroxide | |

Clearly, the description is not limited to the embodiment described and variations may be made to the embodiment without departing from the scope of the invention as defined in the claims.

In particular, the polymer matrix could comprise a different number of synthetic rubber(s) than has been indicated. The matrix could therefore be constituted by two or more synthetic rubbers.

Furthermore, as an alternative to or as a complement to one or more EPDMs, the polymer matrix could comprise one or more synthetic rubbers other than an EPDM such as an EPR, for example. The polymer matrix could therefore be constituted solely by synthetic rubbers selected from EPDM and/or EPR.

The metal hydroxide could also be different from that indicated. As an example, the metal hydroxide could be an aluminum hydroxide or a magnesium hydroxide. The metal hydroxide could be natural or synthetic.

The metal hydroxide may comprise more than one type of filler, in contrast to that indicated and, for example, comprise two types of fillers such as a magnesium hydroxide and an aluminum hydroxide.

The coupling agent could be different from that indicated and could thus, for example, be a coupling agent based on maleic anhydride.

The composition could comprise elements other than has been indicated such as, for example, one or more fillers, one or more anti-oxidants, one or more anti-UV compounds, one or more peroxides, etc.

1. A cable end, such as a cable end for electric power transmission, the cable end comprising an electrically insulating layer obtained from a composition comprising:
a polymer matrix, the polymer matrix being constituted by one or more synthetic rubbers,
a metal hydroxide as a metallic filler, the metal hydroxide being present in the composition in a manner such that the parts by weight of metal hydroxide is greater than the parts by weight of polymer matrix per hundred parts by weight of the composition,
a coupling agent between the polymer matrix and the metal hydroxide, and
a plasticizer.

2. The cable end as claimed in claim 1, wherein the composition comprises between 20 and 40 parts by weight of the polymer matrix per hundred parts by weight of the composition.

3. The cable end as claimed in claim 2, wherein the composition comprises between 30 and 35 parts by weight of the polymer matrix per hundred parts by weight of the composition.

4. The cable end as claimed in claim 1, wherein the polymer matrix is constituted by one or more EPDMs and/or by one or more EPRs.

5. The cable end as claimed in claim 4, wherein at least one of the EPDMs and/or at least one of the EPRs comprises between 15 and 85 parts by weight of ethylene motifs per 100 parts by weight of the EPDM and/or of the EPR under consideration.

6. The cable end as claimed in claim 4, wherein at least one of the EPDMs comprises between 0 parts and 15 parts by weight of diene motifs per 100 parts by weight of the EPDM, the value 0 being excluded from the range.

7. The cable end as claimed in claim 1, wherein the composition comprises between 40 and 70 parts by weight of metal hydroxide per hundred parts by weight of the composition.

8. The cable end as claimed in claim 7, wherein the composition comprises between 45 and 55 parts by weight of metal hydroxide per hundred parts by weight of the composition.

9. The cable end as claimed in claim 1, wherein the metal hydroxide is a natural or synthetic aluminum hydroxide and/or a natural or synthetic magnesium hydroxide.

10. The cable end as claimed in, claim 1 wherein the composition comprises between 0.1 and 2 parts by weight of the coupling agent per hundred parts by weight of the composition.

11. The cable end as claimed in claim 10, wherein the composition comprises between 0.1 and 0.4 parts by weight of the coupling agent per hundred parts by weight of the composition.

12. The cable end as claimed in claim 1, wherein the coupling agent is silane-based.

13. The cable end as claimed in claim 1, wherein the plasticizer is constituted by one or more oils.

14. The cable end as claimed in claim 13, wherein at least one oil is a silicone oil.

15. A method for the manufacture of a cable end as claimed in claim 1, the method comprising the step of mixing the composition and extruding or molding the composition mixed thereby in order to produce said layer.
